(19) United States
(12) Patent Application Publication
(10) Pub. No.: US 2022/0284317 A1
(43) Pub. Date: Sep. 8, 2022

(54) COGNITIVE ANALYTICS FOR CLASSIFYING A REAL WORLD CONTEXT INTO A SITUATION CATEGORY

(71) Applicant: International Business Machines Corporation, Armonk, NY (US)

(72) Inventors: Gautam Lolla, Andhra Pradesh (IN); Prapul Kumar Kareti, Visakhapatnam (IN); SriRanganath Tottadi, Visakhapatnam (IN)

(21) Appl. No.: 17/189,304

(22) Filed: Mar. 2, 2021

(51) Int. Cl. G06N 5/04; G06K 9/62

(52) U.S. Cl. CPC G06N 5/04; G06K 9/6267

(57) ABSTRACT

Computer technology for receiving a user context data set that includes information regarding a current factual context of a user, receiving a plurality of situation classifications respectively corresponding to a plurality of situation types, and applying, by machine logic, cognitive analytics to select a first situation classification from the plurality of situation classifications based upon: the user context data set; a first mode of interaction by end user, which is recorded and/or live recording of any conversation; a second mode of interaction by end user, which is open-ended text that has been entered by the user; and/or a third mode of interaction by end user, which includes sharing of any location, person and/or image by the user.

### BACKGROUND

The present invention relates generally to the field of cognitive analytics, and more particularly to cognitive analytics for analyzing situations that are occurring, or have occurred in the real world. These real world situations are herein variously referred to as “contexts” or “real world context.” For example, as I type this sentence I am sitting at a brown desk and listening to soft music on a streaming service. This is a partial description of a couple of salient features of my current real world context as I am drafting the document that you are now reading. Your own current real world context is whatever you are seeing, hearing, tasting, smelling or feeling through sense of touch right now. This current context may also include background information, such as your eye color, or the number of patent documents that you have already read today before reading this patent document. Most sets of context data do not capture every possible aspect and/or factual circumstance of a user's context, but, instead, includes parameter values for what are considered to be the most situationally relevant aspects, expressed as parameter values, of a given user's context.

For purposes of this document, “cognitive analytics” is defined as follows: Cognitive analytics is any set of computer software and/or hardware (collectively herein referred to as “machine logic”) that applies intelligent technologies to bring multiple data sources within reach of analytics processes for decision making and business intelligence. This is achieved by applying human like intelligence to certain tasks, such as understanding not only the words in a text, but the full context of what is being written or spoken, or recognizing objects in an image within large amounts of information. Cognitive analytics brings together a number of intelligent technologies to accomplish this, including semantics, artificial intelligence algorithms and a number of learning techniques such as deep learning and machine learning. Applying such techniques, a cognitive application can get smarter and more effective over time by learning from its interactions with data and with humans. Cognitive analytics is characterized by a data forward approach that starts and ends with the substance and content of the information. This manner of approaching the entirety of information (all types and at any scale) reveals connections, patterns and collocations that enable unprecedented, even unexpected insight.

### SUMMARY

According to an aspect of the present invention, there is a method, computer program product and/or system that performs the following operations (not necessarily in the following order): (i) receives a user context data set that includes information regarding a current factual context of a user; (ii) receives a plurality of situation classifications respectively corresponding to a plurality of situation types; and (iii) applies, by machine logic, cognitive analytics to select a first situation classification from the plurality of situation classifications based at least upon: (a) the user context data set, and (b) a first mode of interaction by end-user, which is recorded and/or live recording of any conversation.

According to an aspect of the present invention, there is a method, computer program product and/or system that performs the following operations (not necessarily in the following order): (i) receives a user context data set that includes information regarding a current factual context of a user; (ii) receives a plurality of situation classifications respectively corresponding to a plurality of situation types; and (iii) applies, by machine logic, cognitive analytics to select a first situation classification from the plurality of situation classifications based at least upon: (a) the user context data set, and (b) a first mode of interaction by end user, which is open-ended text that has been entered by the user.

According to an aspect of the present invention, there is a method, computer program product and/or system that performs the following operations (not necessarily in the following order): (i) receives a user context data set that includes information regarding a current factual context of a user; (ii) receives a plurality of situation classifications respectively corresponding to a plurality of situation types; and (iii) applies, by machine logic, cognitive analytics to select a first situation classification from the plurality of situation classifications based at least upon: (a) the user context data set, and (b) a first mode of interaction by end user, which includes sharing of any location, person and/or image by the user.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a screenshot view generated by the first embodiment system; and

FIG. 5 is a flowchart according to an embodiment of the present invention.

### DETAILED DESCRIPTION

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product at any possible technical detail level of integration. The computer program product may include a computer readable storage medium (or media) having computer readable program instructions thereon for causing a processor to carry out aspects of the present invention. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

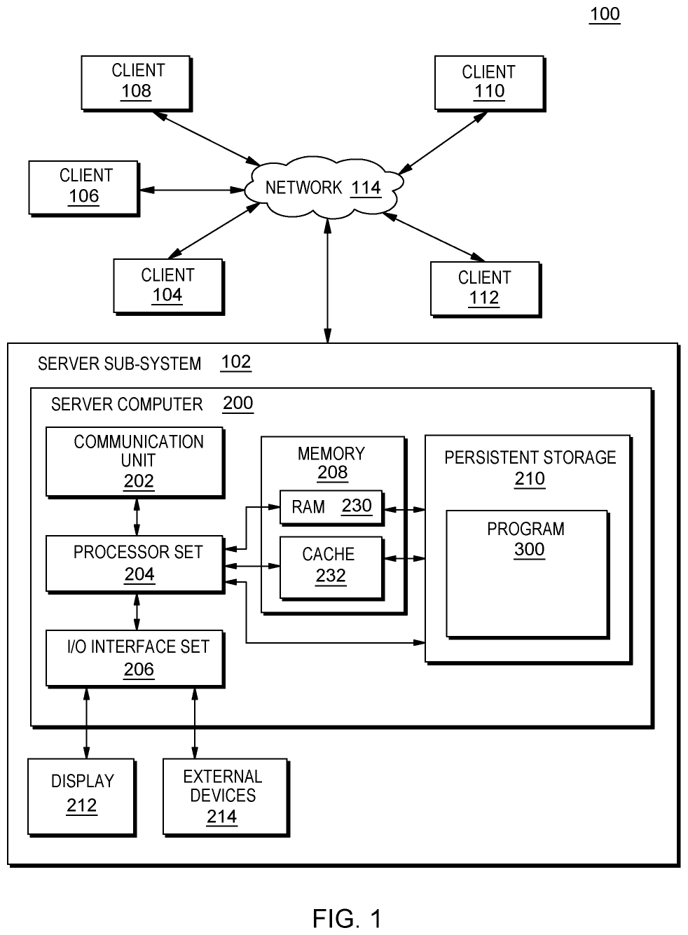

As shown in FIG. 1, networked computers system 100 is an embodiment of a hardware and software environment for use with various embodiments of the present invention. Networked computers system 100 includes: server subsystem 102 (sometimes herein referred to, more simply, as subsystem 102); client subsystems 104, 106, 108, 110, 112; and communication network 114. Server subsystem 102 includes: server computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

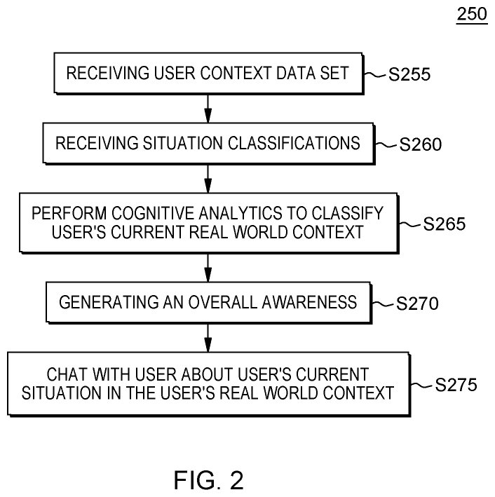

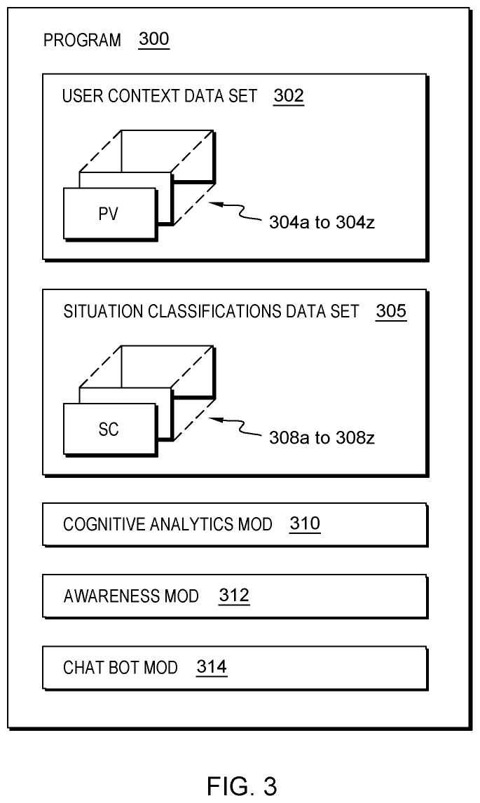

As shown in FIG. 1, networked computers system 100 is an environment in which an example method according to the present invention can be performed. As shown in FIG. 2, flowchart 250 shows an example method according to the present invention. As shown in FIG. 3, program 300 performs or controls performance of at least some of the method operations of flowchart 250. This method and associated software will now be discussed, over the course of the following paragraphs, with extensive reference to the blocks of FIGS. 1, 2 and 3.

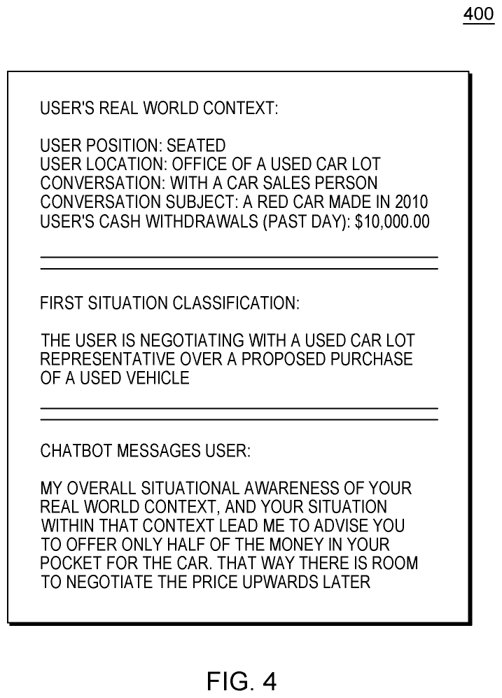

Processing begins at operation S255, where user context data set 302 is received. Data set 302 includes information regarding a current factual context of a user in the form of context parameter values 304a to 304z (see, top portion of screenshot of FIG. 4, where parameter values 304a to 304e are shown). In this example, data set 302 is received through communication network 114 from client subsystem 104, which collects context data in any manner currently conventional and/or to be developed in the future. In this example, the parameter values show that the user is engaged in conversation with a used car salesperson at a used car lot. In this simple example, readers can intuit from common sense and typical human experience, that this makes it at least somewhat likely that the user is currently trying to purchase a used vehicle. One of the parameter values (picked up by the microphone of the user's smart phone and reported to client subsystem 104) indicates that the vehicle being considered for purchase is red and has a model year of 2010. Further audio and/or video monitoring and/or consultation of databases (for example, database with an ad listing the vehicles currently for sale at the lot) might help refine and make more granular the description of what vehicle is being considered for purchase by the user. This could lead to other meaningful info, like a “blue book value” for the vehicle the user is considering. However, at the time of the screenshot of FIG. 4, the most pertinent context information that has been obtained is shown in the top portion of the screenshot of FIG. 4.

Processing proceeds to operation S260, where situation classifications data set 306 is received. Data set 306 includes multiple situation classifications 308a to 308z. Each situation classification 308a to 308z respectively corresponds to a type of situation that a user may encounter as the user attends to her affairs in the world. Situation classification 308z is as follows: negotiating with a used car lot representative.

Processing proceeds to operation S265, where cognitive analytics mod 310 applies cognitive analytics to select a first situation classification that sufficiently matches the user's current context. In some situations, there may not be a sufficient match. For example, if the user is doing something unusual, the situation may be so uncommon that no situation classification could reasonably be expected to be available. However, in this simple example, there is clearly a match, which is situation classification 308z: negotiating with a used car lot representative. The fact that mod 310 has discovered this match is shown in the middle portion of screenshot 400 of FIG. 4. The situation classification matching of mod 310 is based at least upon: (i) the user context data set 302 (see top portion of screenshot of FIG. 4), (ii) a first mode of interaction by end user, which is recorded and/or live recording of any conversation (that is, audio of the user and the used car lot representative speaking about a red car), (iii) a second mode of interaction by end user, which is open-ended text that has been entered by the user (in this example, the user texted her spouse to say that she needs a new used car), and (iv) a third mode of interaction by end user, which includes sharing of any location, person and/or image by the user (in this example, the user's current location in the building of the used car lot is known because the user has turned on location sharing).

Processing proceeds to operation S270, where awareness mod 312 generates an overall awareness of the first situation classification and the user's involvement with the first situation classification specifically within the current factual context. In this example, this overall awareness is evinced by the text shown at the bottom portion of the screenshot of FIG. 4.

This concept of overall awareness and the technology that makes it possible to generate an overall awareness will now be discussed. Some embodiments involve a system where users can communicate with it, and in turn, can derive situational decisions for the real time scenarios faced by them. By using AI (artificial intelligence) techniques in conjunction with the decision tree, some embodiments will enhance the overall awareness of the end user, so that the best possible actions/decision can be made by the user. Here, awareness is nothing, but the end user will get the complete understanding of the real time situation/scenario he/she is facing, and then based on this, he/she can make the best possible decision/action for the situation/scenario. There may be a situation/scenario where the user is unable to make a decision or act upon the situation due to a lack of knowledge about the situation/scenario. In this particular scenario/situation, embodiments of the present invention come into place. Here the system gets the user input, interprets the data received (it can be either by text input, image, voice or video), and analyses the data and generates the best possible responses to the user by deriving all complex scenarios/situations that the user may come across for that situation. Further, the system will suggest to the user the best possible decisions/actions that he/she should take with respect to the situations he/she is facing. Also, in some cases there might be a case where the system may not be able to give any suggestion/solutions. In this case, it will point the user to it related external links/apps/websites where the user can get the proper information to make a correct decision. Here, the system will enhance the decision-making capability of the user. The system will take feedback from the user, such as the impact of the system's solution for the scenario faced, so that it can auto improve its decision making capability in future for that scenario.

Processing proceeds to operation S275, where chatbot mod 314 sends a chat message to the user at her smart phone computer device (in this example, client subsystem 106). This message is shown in the bottom portion of the screenshot of FIG. 4. This message is an example of an exchange of information with the user, with the exchange of information relating to the user's involvement with the first situation classification specifically within the current factual context of the user.

### III. Further Comments and/or Embodiments

A method according to an embodiment of the present invention includes the following operations (not necessarily in the following order): (i) gathering inputs from a user in one or more modes of interactions for determining at least one complex situation which the user came across, using clustering and classification techniques, wherein the modes of interactions by the user can be recorded or live (audio/video) of any conversation or situation, and the user can input any open-ended text or share location/person images; (ii) creating an overall awareness on the determined complex situations to the user and providing through text/documentation output and voice assistance; (iii) suggesting one or more decision-making ideas to the user spontaneously based on evaluated different dimensions of the complex situations using a decision tree, wherein the decision-making ideas lead to a positive/negative impact, percent of decisions made by other users, corresponding to similar situations and the best possible decision for the situation; and (iv) providing a reference of relevant blogs/journals/videos available and refer to any available application which can help the user in decision making, if the system is unable to provide any decision-making advice.

Some embodiments of the present invention may include one, or more, of the following operations, features, characteristics and/or advantages: (i) the system is capable of dynamically determining the complex situations the end-user may come across and the difficulty being faced with decision making; (ii) the system is capable of providing situational awareness for each of the derived situations to the end-user (that is, the system is capable of acting as a virtual assistant to the user in the required situation); (iii) the system is capable of deriving decisions to the complex situations the user is facing at the current time; (iv) the system, by using its clustering capabilities, is able to segregate the decisions into positive/negative decisions; (v) the system is capable of analyzing the decisions made by the user for a particular situation and suggests to him/her the positive/negative impacts of that decision; (vi) the system inherits the interpretations from different individuals about its awareness and decision-making suggestions, and is capable of correcting itself; and/or (vii) if the system is not capable of deriving the situations/decisions, then the system provides a reference of relevant blogs/journals/videos available or refers the user to available applications which can help the user in decision making.

Some embodiments of the present invention may include one, or more, of the following operations, features, characteristics and/or advantages: (i) derives situations that the user may come across based on the users input; (ii) the system derives the circumstances which the user may come across and provides awareness to all the derived situations; (iii) dynamically generates the decisions and their circumstances to the user to make proper and positive decisions; and/or (iv) if the system is unable to provide decision-making advice, the system is capable of providing a reference of relevant blogs/journals/videos available, or refer to an available application, which can help the user in decision making.

Some embodiments of the present invention may include one, or more, of the following operations, features, characteristics and/or advantages: (i) derives the situations that the user may come across based on the users input and then provides the awareness of the situation; (ii) derives the circumstances which the user may come across; (iii) provides awareness to all the derived situations; and/or (iv) provides the decision making details.

Some embodiments of the present invention may include one, or more, of the following operations, features, characteristics and/or advantages: (i) includes immediate decisions that need to be made when a situation is faced by a user; (ii) takes user input through different means including: (a) recorded/live recording (voice/video) of any conversation or situation. (b) the user can enter any open-ended text, and/or (c) the user can share any location/person/image; and/or (iii) the system, irrespective of persona, can judge the situation and provide suggestions based on the situation faced by the user and provides the best possible decision that needs to be made.

Some embodiments of the present invention may include one, or more, of the following operations, features, characteristics and/or advantages: (i) takes input from the user regarding the dynamic situation the user faces and: (a) gathers all the related information of the derived situations dynamically, and uses the information to generate a best possible decision-making result for the situations and presents it to the end-user, and/or (b) the decision-making results will be provided to the user with complete details including: (1) what percent of decisions are made by others with respect to similar situations, (2) what is the positive/negative impact of the particular decision, and/or (3) provides the best possible decision for the situation; (ii) the system will take feedback from the end user for the decisions provided and performs updates accordingly; (iii) the system will never store any PII (personally identifiable information) data in any stage; and/or (iv) the system will take the inputs from users and: (a) analyzes the situation, (b) analyzes all complex scenarios that may arise, and/or (c) provides the best possible decision/awareness.

Some embodiments of the present invention recognize the following facts, potential problems and/or potential areas for improvement with respect to the current state of the art: (i) situations may occur for individuals, and the response from the individuals, may lead to positive or negative impact; (ii) situations may include different dimensions, and it may not be clear as to the way to respond to give positive results; (iii) some situations may be gender specific and the opposite gender may not be in a situation to respond in the correct way; and/or (iv) decision(s) for many situation(s) may vary as per gender/demographics etc., that is, there is a system: (a) which can interact with the individual and take some input and derive the circumstances/situations the individual may face/has faced, (b) the system in-turn allows the individual to get an awareness of the situations/incidents in which he/she is implicated, (c) the system also suggests to the user the best possible ways to respond to the situation based on different dimensions and thus helps improve decision making, and/or (d) if the user has already responded to the situation, it analyses the response and gives the positive or negative implications of the reaction.

Some embodiments of the present invention recognize the following facts, potential problems and/or potential areas for improvement with respect to the current state of the art: (i) situational awareness and decision making are key to the success of individuals and are now being used as general assessing methods at many levels, be it social or professional; (ii) cannot be sure that all individuals may be aware of the situations which they come across in life; (iii) in general, people learn to react to a situation by looking at others and that may not be the right way all the times; (iv) a person's reaction to a situation may lead to negative impact, as the perception towards a situation may differ between individuals; and/or (v) there may be the same situations/issues faced by several individuals, where all may be in the same situation as whether to act or not to act to the situation.

Some embodiments of the present invention may include one, or more, of the following operations, features, characteristics and/or advantages: (i) the system gathers inputs from end-user in the following formats: (a) recorded/live recording (voice/video) of any conversation or situation, (b) the user can enter any open-ended text, and/or (c) the user can share any location/person/image, (ii) based on the users input, the system can derive the complex situations that the user can come across (for example, using clustering and classification AI techniques); (iii) during system processing, all PII, quasi-identifiers and sensitive information will not be stored or utilized; (iv) based on the complex situations derived, the system can create the overall awareness of the situations to the end-user, where this awareness can be through a text/documentation output or voice assist; and/or (v) in case there is a possibility that the system cannot provide any decision-making result, the system will point to relevant blogs/journals/videos available or point to any available application which can help the user in decision making.

Some embodiments of the present invention may include one, or more, of the following operations, features, characteristics and/or advantages: (i) the system will gather all the related information of the derived situations and dynamically generate the best possible decision-making result for the situation and present it to the end-user; (ii) the decision-making results will be provided to the user with complete detailing including: (a) what percent of decisions are made by others with respect to similar situations, (b) what is the positive/negative impact of the particular decision, and/or (c) the best possible decision for the situation; (iii) if required, the system can also record the individual's decision for the suggested situation for future reference; (iv) the user can enter the decision he/she is willing to make and get the ranking for his/her decision-making skills; and/or (v) the user can enter the positive or negative results that occurred due to the decisions suggested by the system, and the system can updated the data based on the different inputs it received.

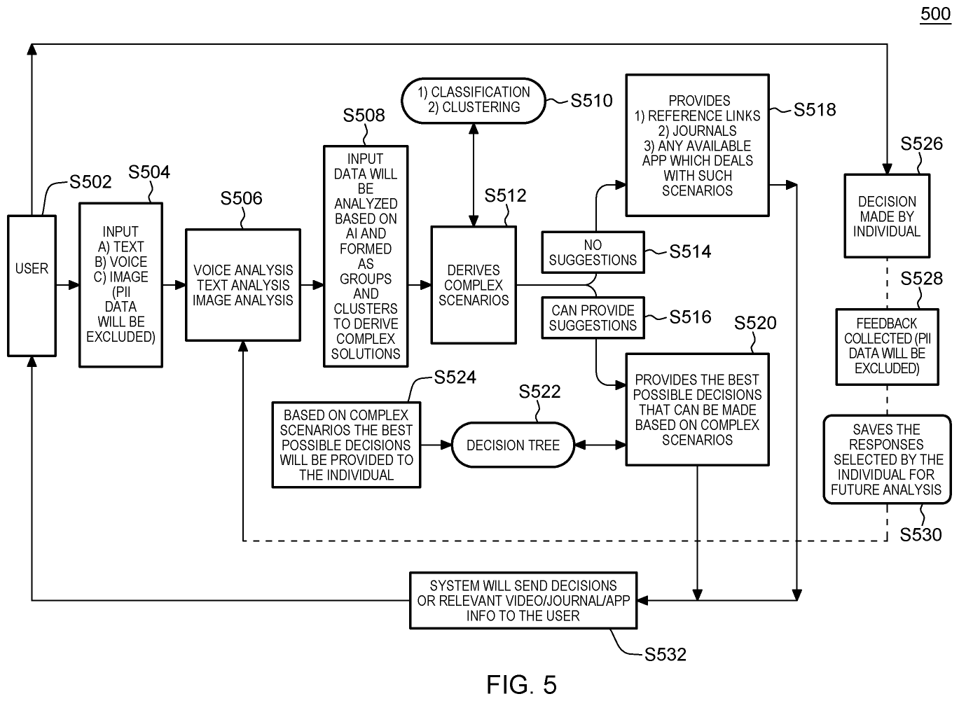

As shown in FIG. 5, flowchart 500 shows an individual reaction. “Individual reaction” is nothing but the end user action with the system: (i) such as providing the input, where the user faces a scenario and is unable to make a decision on his own (see operation S502) to the system; (ii) the system provides suggestions for the scenario/situations suggestions which the user can use to react to his/her situation/scenario (based on suggestions operation S532), and (iii) providing input to system on the suggestion/decision, the user can choose the scenario/situations so that the system can use this for future references (operations S526, S528 and S530).

One embodiment includes the following operations: user block S502; input a) text, b) voice, c) image (PII data will be excluded) block S504; voice analysis, text analysis, image analysis block S506; input data will be analyzed based on AI and formed as groups and clusters to derive complex solutions block S508; 1) classification, 2) clustering block S510; derives complex scenarios block S512; no suggestions block S514; can provide suggestions block S516; provides 1) reference links, 2) journals, 3) any available app which deals with such scenarios block S518; provides the best possible decisions that can be made based on complex scenarios block S520; decision tree block S522; based on complex scenarios the best possible decisions will be provided to the individual block S524; decision made by individual block S526; feedback collected (PII data will be excluded) block S528; saves the responses selected by the individual for future analysis block S530; and system will send decisions or relevant video/journal/app info to the user block S532.

Some embodiments of the present invention may include one, or more, of the following operations, features, characteristics and/or advantages: (i) includes a system and method which is capable of improving the situational awareness and decision-making skills of the individuals by using cognitive analytics; (ii) the system is capable of determining the situations the end-user may come across and classify them based on the following modes of interaction by the end-user: (a) recorded/live recording (voice/video) of any conversation or situation, (b) the user can enter any open-ended text, (c) the user can share any location/person/image, and/or (d) the system is capable of giving an overall awareness of the determined situations to the end-user; and/or (iii) the system is capable of acting as a virtual assistance to the user in the required situation(s).

In operation S502: (i) the user provides the input, where the user faces a scenario and is unable to make a decision on his own (operation S502—input to the system); (ii) the system provides suggestions for the scenario/situations which the user can use to react to his/her situation/scenario (based on suggestions operation S532), and (iii) provides input to the system on the suggestion/decision he chooses, for the scenario/situations, so that the system can use this for future reference (operations S526, S528, S530).

In operation S504, input to the system includes: text, voice, and/or image data. Note that PII data will be excluded as input data to the system.

In operation S506, voice analysis, text analysis, image analysis in the performed by the system.

In operation S508, input data will be analyzed by the system based on AI and formed as groups and clusters to derive complex solutions for the user.

In operation S510, the system performs classification and clustering of the input data.

In operation S512, the system derives complex scenarios. The output from operations S508 and S510 will be done at operation S512.

In operation S514, the system does not offer any suggestions to the user. After analyzing data at operation S512, there may be a scenario where the system may not provide suggestions the user is facing for the situations/scenarios. The system will then provide some external reference links/journal link or even suggest other available applications or websites which will help the user to make a decision or get information on the scenario/situation.

In operation S516, the system can provide suggestions to the user. After analyzing data at operation S512, the system will conclude that it can provide suggestions for the users situations/scenarios.

In operation S518, the system provides reference links, journals, and any available apps that deals with such scenarios. After analyzing data at operation S512, a decision is made at operation S514, where the system will give some external reference links/journal link or suggest other available applications or websites which will help the user to make a decision or get awareness on the scenario/situation.

In operation S520, the system provides the best possible decisions that can be made based on complex scenarios. After analyzing the data at operation S512, and the decision made at operation S516, the system will derive all possible suggestions related to decisions and awareness for the situations/scenarios being faced by the user and also further provides segregated suggestions from decision tree logic at operation S522.

In operation S522, the system performs a decision tree operation scenario. The decision tree will check the suggestions and awareness listed in operation S520 and the best possible decisions from operation S524. The system then provides the final segregated suggestion per operation S520, to the user.

In operation S524, based on complex scenarios, the best possible decisions will be provided to the individual by the system.

In operation S526, decisions are made by the individual user. Some specific examples are set forth below.

In operation S528, feedback is collected by the system and excludes PII data.

In operation S530, the system saves the responses selected by the individual for future analysis.

In operation S532, the system will send decisions or relevant video/journal/app info to the user. Based on the decisions made by the system at operations S514 and S516, the corresponding data is collected at operations S518 and S520. This data is displayed to the user at operation S532. Say for example, the user is at a situation/scenario “A” and is unable to make a decision due to a lack of awareness on the situation/scenario. The user then feeds the input to the system. In the above use case, if the system is unable to provide any suggestions to the user, it will search internet links/journals/websites/mobile apps, etc., which are related to the users input in one way or other, and suggests to the user to go through the provided info to get a possible decision on the situation the user is facing (operation S532). In the same above use case, if the system is able to provide suggestions to the user, then it will gather all the situations/scenarios surrounding the user's input and classify them and provide the user with the best possible decision for the said situation (operation S532).

The following two (2) paragraphs are examples of some embodiments of the present invention.

Example 1: There may be a situation where an employee needs to discuss with his/her manager regarding an issue pertaining to his/her work. In this scenario the system can take inputs (FIG. 5, operation S506) and analyze the issue (FIG. 5, operation S508) and provide the best possible way to communicate to the manager (FIG. 5, operation S512).

Example 2: There may be an “abc” situation which an end-user may face, and he/she has no idea how to handle the situation. The system can explain the situation to the user as a virtual assistance so that he/she can get the proper understanding of the situation (FIG. 5, operations S516 and S520).

Some embodiments of the present invention may include one, or more, of the following operations, features, characteristics and/or advantages: (i) the system, with its decision tree capabilities, is capable of evaluating different dimensions of the generated situations; and/or (ii) the system can give proper decision-making advice to the users spontaneously.

The following two (2) paragraphs are examples of some embodiments of the present invention.

Example 1: There may be an “xyz” situation which a particular end-user may face, and he/she is not able to decide whether to go/not to go (FIG. 5, operation S522). The system can explain the situation, and suggest to the user the best possible decision to make that would not lead to a negative impact (FIG. 5, operation S524).

Example 2: Say there is a potential trade dispute situation between two (2) countries, the system is capable of analyzing the situation based on the various dimensions, like size of the army, and social and economic standards (FIG. 5, operations S510 and S512). After analyzing, the system creates an awareness to the people involved in the decision-making about the impact of the trade dispute on various sectors and it suggests whether it is good to go to continue pursuing the trade dispute and/or possible relief measures related to the trade dispute (FIG. 5, operations S516 and S520).

Some embodiments of the present invention may include one, or more, of the following operations, features, characteristics and/or advantages: (i) by using its clustering capabilities, the system is able to derive decisions that lead to a positive/negative impact; and/or (ii) the system is capable of analyzing the decisions made by the user, for a particular situation, and suggests to him/her the positive/negative impacts of that decision.

The following paragraph is an example of some embodiments of the present invention.

Example: Say an employee has faced “abc” situation with his/her manager and has made a decision. He/she can give the details of the situation to the system and the system can provide the positive/negative impacts of the situation (FIG. 5, operations S526, S528, and S530).

Some embodiments of the present invention may include one, or more, of the following operations, features, characteristics and/or advantages: (i) out of the derived situations, the system is capable of predicting the complex situations where the end-user may be facing difficulty with his/her decision-making; and/or (ii) the system inherits the interpretations from different individuals about its awareness and decision-making suggestions and is capable of correcting itself.

The following paragraph is an example of some embodiments of the present invention.

Example: the user can give details including how well he/she understood the situations with the help of the system, and whether the decisions suggested by system lead to positive or negative results (FIG. 5, operations S516, S520, and S532).

Some embodiments of the present invention may include one, or more, of the following operations, features, characteristics and/or advantages: (i) while recording an individual's decision, the system will ensure all PII data is removed before storing the data; (ii) the user can enter the decision he/she is willing to make and get a ranking for his/her decision-making skills, (iii) the system will take feedback from the user, where the positive or negative results that occurred due to the decisions suggested by the system, and can update the data based on the different inputs it received; and/or (iv) while the user enters the positive or negative results they faced, based on system suggestions, the system will not store any PII, QI or sensitive data.

Some embodiments of the present invention may include one, or more, of the following operations, features, characteristics and/or advantages: (i) the system solution will be helpful for individuals to gain situational awareness on different situations they come across; (ii) the system will improve the decision-making skills of the individuals with respect to the situations they come across; and/or (iii) the system, in-turn helps the individual to develop themselves by creating awareness and decision-making skills.

Some embodiments of the present invention may include one, or more, of the following operations, features, characteristics and/or advantages: (i) the information regarding the current factual context includes at least one of the following types of information: time information, date information, location information, recent financial transactions of the user, recent social media posts of the user, emails of the user, the user's speech, ambient sounds, local motion information regarding the instantaneous position(s), orientation(s) and/or velocity of a user device controlled by the user; and/or (ii) situation types, respectively corresponding to the situation classifications of the plurality of situation classifications, include at least one of the following situation types: eating, bathing, sleeping, waking up, restroom break, exercise, shopping at real world store(s), shopping online, banking, buying insurance, driving, being at a meeting, car repairs, playing video games, working, consuming entertainment media, medical emergencies/accidental situations, travelling, and outdoor game play.

Now, giving some basic examples how this system can be used: The user is planning to invest in a retirement fund and is unable to choose between multiple funds, per the funds past performance and the users future needs. In this case, the user can provide the same input to the system and attach images of past performances of the funds which he is willing to consider. Then: (i) the system will interpret the input provided (operations S504 and S506) by the user (text and image here) and analyzes the funds with respect to various market conditions, economic crisis, etc.; (ii) different AI techniques will be applied on the analysis (operations S508 and S510) and derives all complex scenarios for the funds in consideration as per past performance; (iii) the system will consider the scenarios and decides whether any response can be provided to the user such as, how long he should invest, when to withdraw/when to periodically increase the investment, etc. (operations S516 and S520); (iv) the decision tree will analyze all the possible solutions as per the users future needs, which was given as input, and generates the best possible solution to the end the user (operations S522 and S524); (v) the same will be sent to the end user and the user can choose the solution from the suggestions provided by the system (operation S532); and/or (vi) after some time, the system will request feedback to the user on the outcome of its suggestion. If the user provides his response to the system, it will store the data and improve its decision making capabilities in the future for similar requests from the user.

As an example, the user is making a request of the system regarding vaccines and asks which one he should take as per his current and past medical condition by uploading images of his prescriptions, scan reports, video analysis from doctors, etc. In this example: (i) the system will interpret the input provided (operations S504 and S506) by the user (text, image, and video) and analyzes the health condition of the user, understands the requirements, and provides a suggestion on the best possible vaccine on the market; (ii) different AI techniques will be applied on vaccines available with respect to impact and effects (operations S508 and S510); (iii) the system will then check if it can provide any possible suggestion to the end user. If it is incapable of giving any suggestion with respect to what vaccine to take, as per the users health conditions (citing limited public data to interpret for side effects as per the user health condition) it will provide reference links to various medical journals to the end user. The system can also provide various articles published for vaccines available by date, and as per his geography, and provide government related apps for vaccines and related information (operations S516 and S518); (iv) the same will be sent to the end user and the user can then choose the solution from the suggestions provided by the system (operation S532); and/or (v) after some time period, the system will request feedback from the user on the action the user has taken. If the user provides his/her response to the system, it will store the data and improve its decision making capabilities for future similar requests from the user.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer implemented method (CIM) comprising:
receiving a user context data set that includes information regarding a current factual context of a user;
receiving a plurality of situation classifications respectively corresponding to a plurality of situation types; and
applying, by machine logic, cognitive analytics to select a first situation classification from the plurality of situation classifications based at least upon: (i) the user context data set, and (ii) a first mode of interaction by end user, which is recorded and/or live recording of any conversation.

2. The CIM of claim 1 wherein the information regarding the current factual context includes at least one of the following types of information: time information, date information, location information, recent financial transactions of the user, recent social media posts of the user, emails of the user, the user's speech, ambient sounds, local motion information regarding the instantaneous position(s), orientation(s) and or velocity of a user device controlled by the user.

3. The CIM of claim 1 wherein situation types, respectively corresponding to the situation classifications of the plurality of situation classifications, include at least one of the following situation types: eating, bathing, sleeping, waking up, restroom break, exercise, shopping at real world store(s), shopping online, banking, buying insurance, driving, at a meeting, car repairs, playing video games, working, consuming entertainment media, medical emergencies, accident situations, travelling and/or outdoor game play.

4. The CIM of claim 1 wherein the first mode is recorded and/or live recording of any conversation that includes the user.

5. The CIM of claim 1 wherein the application of cognitive analytics to select a first situation classification from the plurality of situation classifications is further based at least upon a second mode of interaction by end-user, which is open-ended text that has been entered by the user.

6. The CIM of claim 5 wherein the application of cognitive analytics to select a first situation classification from the plurality of situation classifications is further based at least upon a third mode of interaction by end user, which includes sharing of any location, person and/or image by the user.

7. The CIM of claim 1 wherein the application of cognitive analytics to select a first situation classification from the plurality of situation classifications is further based at least upon a second mode of interaction by end user, which sharing of any location, person and/or image by the user.

8. The CIM of claim 1 further comprising:
generating, by machine logic, an overall awareness of the first situation classification and the user's involvement with the first situation classification specifically within the current factual context of the user.

9. The CIM of claim 1 further comprising:
engaging, by machine logic in the form of a virtual assistant, in an exchange of information with the user, with the exchange of information relating to the user's involvement with the first situation classification specifically within the current factual context of the user.

10. The CIM of claim 1 wherein the first situation classification is work pursuant to an employment situation of the user, with the CIM further comprising:
communicating, over a communication network and to the user's device a possible way to communicate to a manager of the user at the user's employment situation.

11. The CIM of claim 1 further comprising:
explaining the first situation classification to the user through electronic communication(s) so that the user obtains a proper understanding of the current factual context of the user.

12. The CIM of claim 1 further comprising:
evaluating different dimensions of the current factual context of the user; and
based on the evaluation, spontaneously giving proper decision-making advices to the user.

13. The CIM of claim 1 further comprising:
helping the user to decide whether to go or not to go in order to avoid negative impact.

14. A computer implemented method (CIM) comprising:
receiving a user context data set that includes information regarding a current factual context of a user;
receiving a plurality of situation classifications respectively corresponding to a plurality of situation types; and
applying, by machine logic, cognitive analytics to select a first situation classification from the plurality of situation classifications based at least upon: (i) the user context data set, and (ii) a first mode of interaction by end user, which is open-ended text that has been entered by the user.

15. The CIM of claim 14 wherein the application of cognitive analytics to select a first situation classification from the plurality of situation classifications is further based at least upon a second mode of interaction by end user, which includes sharing of any location, person and/or image by the user.

16. The CIM of claim 14 further comprising:
generating, by machine logic, an overall awareness of the first situation classification and the user's involvement with the first situation classification specifically within the current factual context of the user.

17. A computer implemented method (CIM) comprising:
receiving a user context data set that includes information regarding a current factual context of a user;
receiving a plurality of situation classifications respectively corresponding to a plurality of situation types; and
applying, by machine logic, cognitive analytics to select a first situation classification from the plurality of situation classifications based at least upon: (i) the user context data set, and (ii) a first mode of interaction by end user, which includes sharing of any location, person and/or image by the user.

18. The CIM of claim 17 further comprising:
generating, by machine logic, an overall awareness of the first situation classification and the user's involvement with the first situation classification specifically within the current factual context of the user.
